(19) United States
(12) Patent Application Publication
(10) Pub. No.: US 2016/0162272 A1
(43) Pub. Date: Jun. 9, 2016

(54) METHOD AND APPARATUS FOR LOADING A RENDERING ENGINE

(71) Applicant: TENCENT TECHNOLOGY (SHENZHEN) COMPANY LIMITED, Shenzhen (CN)

(72) Inventors: LI ZHANG, Shenzhen (CN); KE SU, Shenzhen (CN); ZHEN CHEN, Shenzhen (CN); DAIGUO ZHOU, Shenzhen (CN); SHUDONG RUAN, Shenzhen (CN); SHA MO, Shenzhen (CN); WANXIN WANG, Shenzhen (CN)

(73) Assignee: TENCENT TECHNOLOGY (SHENZHEN) COMPANY LIMITED

(21) Appl. No.: 15/042,340

(22) Filed: Feb. 12, 2016

Related U.S. Application Data
(63) Continuation of application No. PCT/CN2014/083367, filed on Jul. 31, 2014.

(30) Foreign Application Priority Data
Aug. 15, 2013 (CN) 2013-10355868.9

(51) Int. Cl. G06F 9/445

(52) U.S. Cl. CPC G06F 8/61; G06F 9/44521

(57) ABSTRACT

A method is provided for loading a rendering engine of a browser on a mobile terminal. The method includes receiving a user interface installation file and a rendering engine file separately and independently when an update to the browser is needed, wherein the user interface installation file includes a user interface module and an interface adapter module. The method also includes installing the received user interface installation file. Further, the method includes loading dynamically a corresponding function file and an object library file in the rendering engine file through the interface adapter module when an application runs. The corresponding function file and the object library file are not compiled together with the user interface adapter module.

### CROSS-REFERENCES TO RELATED APPLICATIONS

This application is a continuation application of PCT Patent Application No. PCT/CN2014/083367, filed on Jul. 31, 2014, which claims priority of Chinese Patent Application No. 201310355868.9, filed on Aug. 15, 2013, the entire contents of both of which are incorporated by reference herein.

### FIELD OF THE INVENTION

The present invention generally relates to the field of communication technologies, more particularly, to methods and apparatuses for loading a rendering engine of a browser.

### BACKGROUND

With the development of mobile communication technologies, mobile terminals (e.g., mobile phones) not only have remote communication functions, but also realize many personal computer application functions. For example, a user may browse webpage contents through a browser installed on a mobile phone, play audios and videos through a player installed on the mobile phone, and edit documents through a document processing tool installed on the mobile phone.

Currently, the browser installed on the mobile terminal usually includes a user interface (UI) and a rendering engine. FIG. 1 illustrates a structure schematic diagram of an exemplary existing browser on a mobile terminal. As shown in FIG. 1, a rendering engine consists of java codes and a shared object (.so) library (the so library is an object library which is used to store some files needed by system services and applications). When the browser is launched, the java codes and the so library in the rendering engine are loaded into runtime environment.

However, when loading the existing browser rendering engine, the user interface and the rendering engine are tightly connected, and the user interface and the rendering engine cannot be separated dynamically. Therefore, the user interface and the rendering engine need to be integrated together for releasing a browser product or a browser update installation package. When the browser needs to be updated (either the user interface or the rendering engine needs to be updated), a user must download the entire update installation package, consuming additional network traffic flow and time. Further, because the installation package contains large content, when built-in memory storage of the mobile terminal is insufficient, it is not convenient to build the browser into the mobile terminal, having higher requirements on system hardware resources.

In addition, because the size of the so library file is large, some developers propose to dynamically load the so library, whereas the java codes of the rendering engine are not changed. The size of the installation package is relatively reduced by using this method, and it is more convenient to download the installation package. However, because the so library has a close connection with the java codes, the so library and the Java codes usually need to be updated together. Java specification defines that a java native interface (JNI) loads the so library, but a limitation is that a native method (i.e., Java calls an interface function of other programming languages) needs to have one-to-one correspondence with a Java defined method. Therefore, when only the so library is changed, but the Java file is not changed, the rendering engine cannot run. This method cannot meet the requirement of updating the rendering engine. Each time the rendering engine is updated, the user interface is also updated. That is, the user interface and the rendering engine still cannot be separated. When the browser is updated, both the user interface and the rendering engine need to be updated. Therefore, when downloading the installation package, it still consumes more traffic flow and time. Because the rendering engine is an important aspect of computer technology dealing with web browsing applications, technical solutions are needed to solve and/or improve the issues associated with the existing browser rendering engines.

The disclosed methods and apparatuses are directed to solve one or more problems set forth above and other problems.

### BRIEF SUMMARY OF THE DISCLOSURE

One aspect of the present disclosure includes a method for loading a rendering engine. The method includes receiving a user interface installation file and a rendering engine file separately and independently when an update to the browser is needed, wherein the user interface installation file includes a user interface module and an interface adapter module. The method also includes installing the received user interface installation file. Further, the method includes loading dynamically a corresponding function file and an object library file in the rendering engine file through the interface adapter module when an application runs. The corresponding function file and the object library file are not compiled together with the user interface adapter module.

Another aspect of the present disclosure includes an apparatus for loading a rendering engine of a mobile browser. The apparatus includes an updating file receiving unit configured to, when an update to the browser is needed, receive a user interface installation file and a rendering engine file separately and independently, wherein the user interface installation file includes a user interface module and an interface adapter module. The apparatus also includes an installation unit configured to install the received user interface installation file. Further, the apparatus includes a loading unit configured to, when an application runs, dynamically load the corresponding function file and the object library file in the rendering engine file through the interface adapter module, wherein the corresponding function file and the object library file are not compiled together with the user interface adapter module.

Another aspect of the present disclosure includes a non-transitory computer-readable medium having computer program. When being executed by a processor, the computer program performs a method for loading a rendering engine of a browser on a mobile terminal. The method includes, when an update to the browser on the mobile terminal is needed, receiving a user interface installation file and a rendering engine file separately and independently. The user interface installation file includes a user interface module and an interface adapter module. The method also includes installing the received user interface installation file and, when an application runs, loading dynamically a corresponding function file and an object library file in the rendering engine file through the interface adapter module. The corresponding function file and the object library file are not compiled together with the user interface adapter module.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a structure schematic diagram of an existing mobile browser;

FIG. 2 illustrates a flow chart of an exemplary process for loading a rendering engine consistent with the disclosed embodiments;

FIG. 3 illustrates a flow chart of another exemplary process for loading a rendering engine consistent with the disclosed embodiments;

FIG. 4 illustrates a schematic diagram of an exemplary development process of file updating on a browser with an android system consistent with the disclosed embodiments;

FIG. 5 illustrates a schematic diagram of an exemplary process of rendering engine loading on a browser with an android system consistent with the disclosed embodiments;

FIG. 6 illustrates a structure schematic diagram of an exemplary apparatus for loading a rendering engine consistent with the disclosed embodiments;

FIG. 7 illustrates a structure schematic diagram of another exemplary apparatus for loading a rendering engine consistent with the disclosed embodiments;

FIG. 8 shows a block diagram illustrating an exemplary computing system consistent with the disclosed embodiments; and

FIG. 9 illustrates a schematic diagram of an exemplary browser for loading a rendering engine on a mobile terminal consistent with the disclosed embodiments.

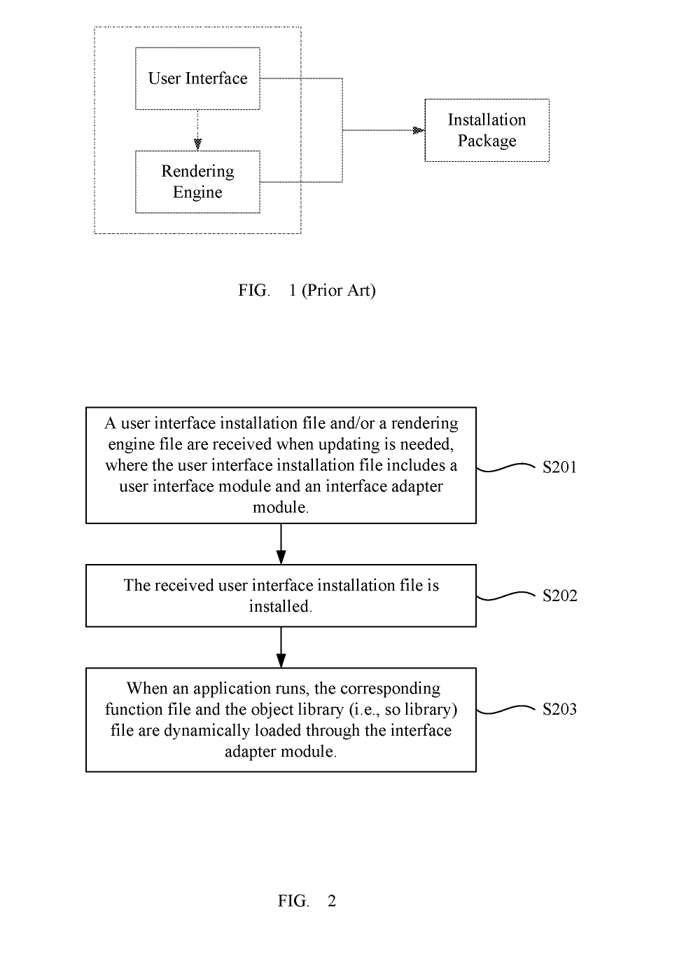

### DETAILED DESCRIPTION

In the following description, for purposes of illustration, many specific details are illustrated in order to provide a full understanding of one or more embodiments. However, obviously, those embodiments can also be implemented in the case of these specific details changed, replaced, or alternated. The followings, together with accompanying drawings, describe in detail certain embodiments of the present invention.

As used herein, the term “rendering engine” (sometimes called layout engine, browser core, or browser engine) is a software component used in a web browser that takes marked up web content (such as HTML, XML, image files, etc.) and formatting information (such as CSS, XSL, etc.) and displays the formatted content on a screen. For example, if the requested content is HTML, the rendering engine parses HTML and displays the parsed content.

As used herein, the term “application package file (apk)” is the package file format used to distribute and install application software and middleware onto Google's Android operating system.

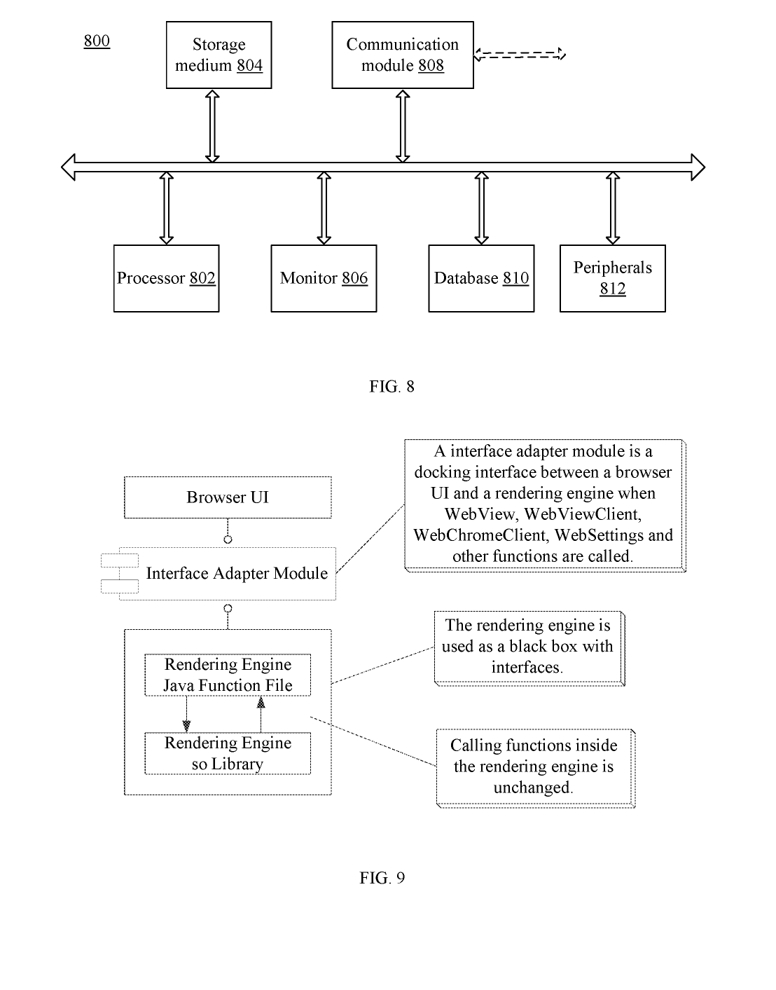

A mobile browser may refer to a web browser installed on a mobile terminal, such as a mobile phone, a smart phone, a pad, a tablet computer, a laptop computer, or any type of mobile computing device. FIG. 8 shows a block diagram illustrating an exemplary computing system for implementing a mobile terminal.

As shown in FIG. 8, the exemplary computer system 800 may include one or more processors 802, a storage medium 804, a monitor 806, a communication module 808, a database 810, peripherals 812, and one or more bus 814 to couple the devices together. Certain devices may be omitted and other devices may be included.

The processor 802 can include any appropriate processor or processors. Further, the processor 802 can include multiple cores for multi-thread or parallel processing. For example, the processor 802 may load a rendering engine of a browser. The storage medium 804 may include memory modules, such as ROM, RAM, and flash memory modules, and mass storages, such as CD-ROM, U-disk, removable hard disk, etc. The storage medium 804 may store computer programs (e.g., a browser) for implementing various processes, when executed by the processor 802.

The monitor 806 may include display devices for displaying browser windows. For example, the monitor 806 of the terminal device can be used by a user to display browser windows. The communication module 808 may include network devices for establishing connections through the communication network. The database 810 may include one or more databases for storing certain data and for performing certain operations on the stored data. Further, the peripherals 812 may include I/O devices such as keyboard and mouse.

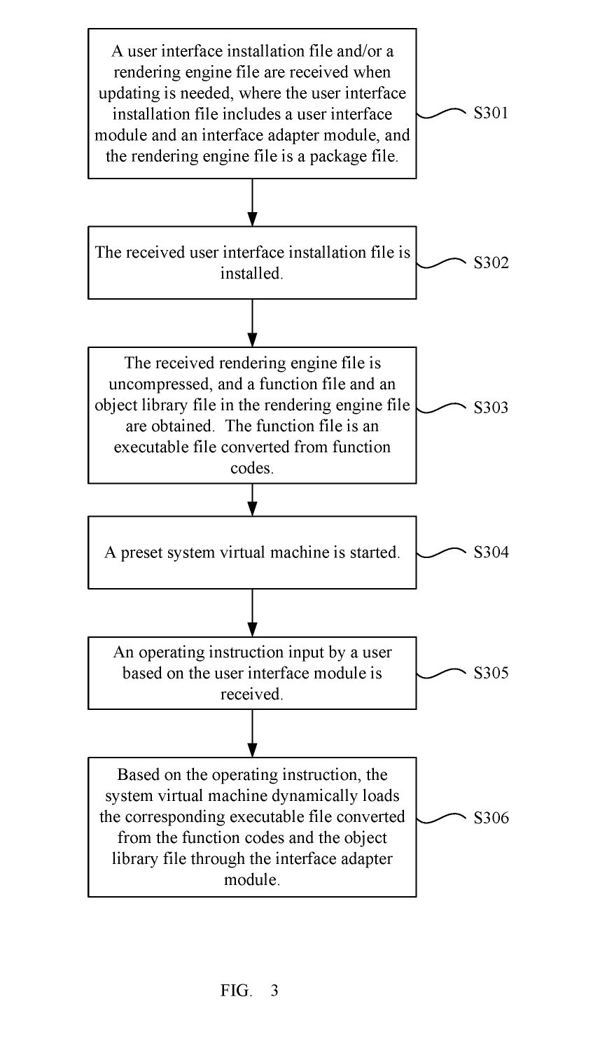

In operation, the mobile terminal may need to update the browser installed on the mobile terminal. More specifically, according to the disclosed embodiments, components such as the rendering engine of the browser may be separately updated. FIG. 2 illustrates a flow chart of an exemplary process for loading a rendering engine consistent with the disclosed embodiments.

As shown in FIG. 2, the loading process may include the following steps.

S201: a user interface (UI) installation file and/or a rendering engine file are received when an update is needed, where the user interface installation file includes a user interface module and an interface adapter module.

The interface adapter module is configured to provide an interface for the user interface module. The interface adapter module abstracts objects and functions needed by the user interface module into interfaces. Therefore, the user interface module can call the objects and the functions in the rendering engine through these interfaces.

Using a browser as an example, FIG. 9 illustrates a schematic diagram of an exemplary browser for loading a rendering engine on a mobile terminal consistent with the disclosed embodiments. As shown in FIG. 9, an interface adapter module is a docking interface between a user interface and a rendering engine when WebView, WebViewClient, WebChromeClient, WebSettings and other functions are called. The rendering engine is used as a black box with interfaces, and calling functions inside the rendering engine is unchanged.

S202: the received user interface installation file is installed.

S203: when an application runs, the corresponding function file and the object library (i.e., so library) file are dynamically loaded through the interface adapter module.

The running of the application may refer to operations performed in order to achieve a certain function or operation after the application is launched. For example, after a user clicks an operating button of a user interface, an application starts running. Therefore, the method that the function file and the object library file are loaded when the application runs is called a dynamic loading method.

The functions and the files in the rendering engine can be loaded through a system virtual machine. Using an android operating system as an example, functions of the rendering engine can be converted to an executable file (i.e., a dex file) in advance. Then, the dex file and the so library file are dynamically loaded using a dalvik virtual machine (dvm) of the system when an application program runs. The dvm in the android operating system is a process virtual machine that runs the apps on android devices such as mobile phones and tablet computers. The process virtual machine runs as a normal application inside a host operating system and supports a single process. The process virtual machine is created when that process is started and destroyed when it exits. The purpose is to provide a platform-independent programming environment that abstracts away details of the underlying hardware or operating systems, and allows an application program to execute in the same way on any platform.

By adding the interface adapter module in the user interface installation file, the dynamic loading of the rendering engine is realized, and the separation of the user interface and the rendering engine is also realized. Therefore, when updating, any one of the user interface and the rendering engine can be updated separately. Comparing to the existing updating methods, the installation is more convenient, and the download traffic flow is saved. It is more suitable for wirelessly downloading and installing. In addition, it is more convenient to build the downloaded file into the limited storage space of the mobile terminal.

Further, the loading process can load simultaneously the function file of the rendering engine (Java codes of the rendering engine) and the object library file, and provide more flexible support for the architecture transformation of the application.

Specially, the followings can be seen from the loading process. If a corresponding interface adapter module is introduced when an application is updated, the user interface can load the corresponding functions and files of the rendering engine. Therefore, the user interfaces of different applications can share a same rendering engine. The use of the rendering engine has versatility, saving a large amount of system resources for the mobile terminal.

FIG. 3 illustrates a flow chart of another exemplary process for loading a rendering engine consistent with the disclosed embodiments. As shown in FIG. 3, the process may include the following steps.

S301: a user interface installation file and/or a rendering engine file are received when an update is needed. The user interface installation file includes a user interface module and an interface adapter module, and the rendering engine file is a compressed file.

S302: the received user interface installation file is installed.

S303: the received rendering engine file is uncompressed, and a function file and an object library file (i.e., so library) in the rendering engine file are obtained. The function file is an executable file (i.e., a dex file) converted from function codes.

S304: a preset system virtual machine is started.

S305: an operating instruction inputted by a user based on the user interface module is received.

S306: based on the operating instruction, the system virtual machine dynamically loads the corresponding executable file converted from the function codes and the object library file through the interface adapter module.

In the loading method provided in FIG. 3, the user interface and the rendering engine are not tightly coupled together, but are integrated together when receiving the operating instruction of the user (that is, when the application runs). However, in the existing technology, the user interface and the rendering engine are integrated together for releasing a browser product or a browser update installation package. Therefore, updating any one of the user interface and the rendering engine independently can be realized.

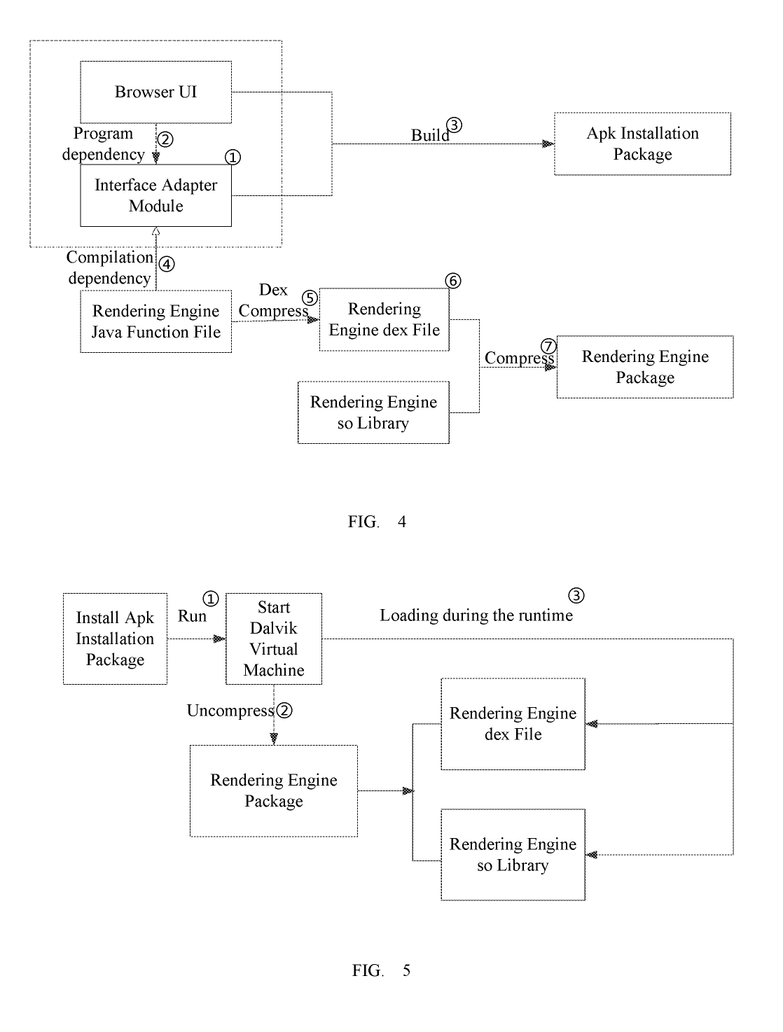

Using a browser in an android operating system as an example, before introducing the process for loading the rendering engine, the development process of the browser and the browser updating file is introduced first. FIG. 4 illustrates a schematic diagram of an exemplary development process of a browser and a browser updating file in an android system consistent with the disclosed embodiments. As shown in FIG. 4, the process may include the followings.

Step 1: an interface adapter module is added in an entire architecture of a browser. Both the object and the method needed by a browser user interface are abstracted as interfaces, thereby more convenient to be called by the user interface.

Step 2: the interface adapter module is configured to provide interfaces for the user interface, such that the user interface can call the functions and files in the rendering engine through the interfaces provided by the interface adapter module.

Step 3: before generating an apk (android package) file to be released (the apk file can be an installation file for installing the browser at the first time, or an installation file for updating the browser), the user interface and the interface adapter module of the browser are compiled together. That is, the apk file contains codes of all interface levels.

Step 4: when Java functions of the rendering engine are developed and compiled, the Java functions of the rendering engine have dependency on the interface adapter module to generate a transitional jar file (i.e., a Java Archive). But the interface adapter module is only as a compilation dependency project, the interface adapter module is not compiled together with the Java functions of the rendering engine to generate an integrated entity.

Step 5: the jar file compiled and generated by the Java functions of the rendering engine is compressed and converted to a dex file that can be loaded dynamically by a dalvik virtual machine in the android system. The dvm developed by Google Company is a Java virtual machine used in an android platform. The purpose is to provide a platform-independent programming environment that abstracts away details of the underlying hardware or operating systems, and allows an application program to execute in the same way on any platform.

Step 6: the dex file generated by the Java functions of the rendering engine is a part of the rendering engine package.

Step 7: the dex file and the so library of the rendering engine are compressed to generate a rendering engine package file that can be released.

When the user interface needs to be updated, the apk installation package is downloaded. When the rendering engine needs to be updated, the rendering engine package is downloaded. FIG. 5 illustrates a schematic diagram of an exemplary process that a browser loads a rendering engine in an android system consistent with the disclosed embodiments. As shown in FIG. 5, the process may include the following steps.

Step 5-1: an apk file of a browser needs to be installed first in an android operating system platform. After installing the apk file, a user can start a user interface on a mobile terminal and load a rendering engine through operations for the user interface. When an application runs, a system can start the dvm automatically.

Step 5-2: when an application program runs, a rendering engine package file is uncompressed to obtain a dex file and a so library.

It should be noted that the rendering engine package file is uncompressed only when the program runs at the first time. That is, the rendering engine package file does not need to be uncompressed again when the program runs again.

Step 5-3: a dvm dynamically loads the dex file and the so library through an interface adapter module during the runtime.

By using the loading method, the browser on the android system platform is separated to two independent parts: the user interface and the rendering engine. Any one of the user interface and the rendering engine is relatively independent of each other. The user interface and the rendering engine are only integrated together when the application runs. Also, the user interface and the rendering engine can be updated independently, avoiding large burden when updating the browser in the existing technology.

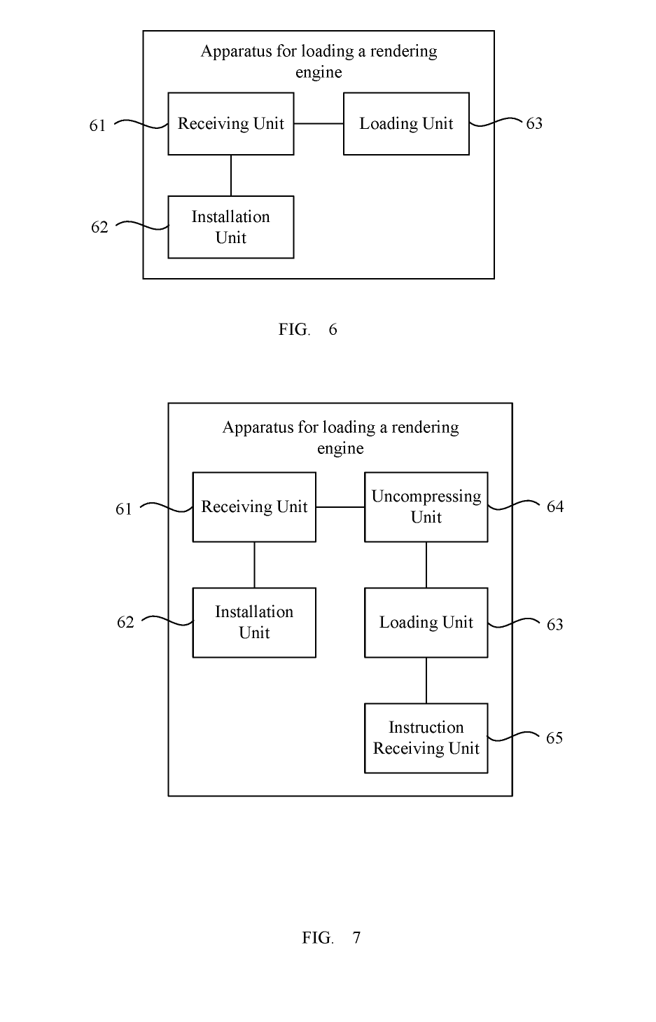

FIG. 6 illustrates a structure schematic diagram of an exemplary apparatus for loading a rendering engine consistent with the disclosed embodiments. As shown in FIG. 6, the apparatus may include an updating file receiving unit 61, an installation unit 62 and a loading unit 63.

The updating file receiving unit 61 is configured to, when an update is needed, receive a user interface installation file and/or a rendering engine file. The user interface installation file includes a user interface module and an interface adapter module. The interface adapter module is configured to provide an interface for the user interface module. The interface adapter module abstracts objects and functions needed by the user interface module into interfaces. That is, the interface adapter module provides interfaces or adapting interfaces between the user interface module and the rendering engine and decouples the user interface module and the rendering engine. Therefore, the user interface module can call the objects and the functions of the rendering engine through these interfaces. Using a browser as an example, the interface adapter module is a docking interface between the user interface and the rendering engine when WebView, WebViewClient, WebChromeClient, Web Settings and other functions are called.

The installation unit 62 is configured to install the user interface installation file received by the updating file receiving unit 61. After the user interface installation file is installed, a user can start the corresponding user interface, and load the rendering engine using the interface adapter module.

The loading unit 63 is configured to, when the application runs, dynamically load the corresponding function file and object library file in the rendering engine file through the interface adapter module. The running of the application may refer to operations performed in order to achieve a certain function or operation after the application is launched. When the function file in the rendering engine file is an executable file converted from function codes, the loading unit 63 can dynamically load the executable file converted from the function codes and the object file in the rendering engine using a system virtual machine.

The apparatus provided in this embodiment separates the user interface and the rendering engine effectively. Therefore, the rendering engine can be dynamically loaded when the application runs. When updating, any one of the user interface and the rendering engine can be updated separately. Comparing to the existing updating methods, the installation is more convenient, and the download traffic flow is saved. Further, as long as the corresponding interface adapter module is introduced in the user interface of the application, the rendering engine can be simultaneously loaded and called by the user interface of multiple applications. The use of the rendering engine has universal features, greatly saving system resources of the mobile terminal.

In addition, the apparatus can load simultaneously the function file of the rendering engine (e.g., java codes of the rendering engine) and the object library file, and provide more flexible support for architecture transformation of the application.

FIG. 7 illustrates a structure schematic diagram of another exemplary apparatus for loading a rendering engine consistent with the disclosed embodiments. Comparing to the apparatus shown in FIG. 6, the apparatus further includes an uncompressing unit 64 and an instruction receiving unit 65.

In order to save the download data flow, the released rendering engine file is usually a compressed file (e.g., a zip file). The uncompressing unit 64 is configured to, when the rendering engine file received by the updating file receiving unit 61 is a compressed file, uncompress the compressed file and obtain a function file and an object library file in the compressed file.

After the installation unit 62 installs the user interface installation file received by the updating file receiving unit 61, the instruction receiving unit 65 is configured to receive an operating instruction inputted by a user according to the user interface module, such that the loading unit 63 dynamically loads the corresponding function file and the object library file in the rendering engine file through the interface adapter module based on the operating instruction.

The user interface and the rendering engine are separated into two independent parts through the apparatus provided. Any one of the user interface and the rendering engine is relatively independent of each other. The user interface and the rendering engine are only integrated together when the application runs. Also, the user interface and the rendering engine can be updated independently, avoiding large burden when updating the browser in the existing technology.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those skilled in the art may implement the described functionality in varying ways for each particular application, but such implementation decisions should not be interpreted as being a departure from the scope of the present invention.

Those skilled in the art should understand that all or part of the steps in the above method may be executed by relevant hardware instructed by a program, and the program may be stored in a non-transitory computer-readable storage medium such as a removable hard disk, a read-only memory (ROM), a random access memory (RAM), a magnetic disk, an optical disk, and so on.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatus for loading a rendering engine, the user interface and the rendering engine are separated into two independent parts through the apparatus provided. Any one of the user interface and the rendering engine is relatively independent of each other. The user interface and the rendering engine are only integrated together when the application runs. Also, the user interface and the rendering engine can be updated independently, avoiding large burden when updating the browser in the existing technology.

What is claimed is:

1. A method for loading a rendering engine of a browser on a mobile terminal, comprising:
when an update to the browser on the mobile terminal is needed, receiving a user interface installation file and a rendering engine file separately and independently, wherein the user interface installation file includes a user interface module and an interface adapter module;
installing the received user interface installation file; and
when an application runs, loading dynamically a corresponding function file and an object library file in the rendering engine file through the interface adapter module, wherein the corresponding function file and the object library file are not compiled together with the user interface adapter module.

2. The method according to claim 1, wherein:
the function file is an executable file converted from function codes.

3. The method according to claim 2, wherein the loading dynamically a corresponding function file and an object library file in the rendering engine file through the interface adapter module further includes:
launching a preset system virtual machine; and
loading dynamically the corresponding executable file converted from the function codes and the object library file in the rendering engine file using the system virtual machine.

4. The method according to claim 1, wherein:
the received rendering engine file is a compressed file.

5. The method according to claim 1, before the loading dynamically a corresponding function file and an object library file in the rendering engine file through the interface adapter module, further including:
uncompressing the received rendering engine file; and
obtaining the function file and the object library file in the rendering engine file.

6. The method according to claim 1, wherein the loading dynamically a corresponding function file and an object library file in the rendering engine file through the interface adapter module further includes:
receiving an operating instruction input by a user according to the user interface module; and
based on the operating instruction, loading dynamically the corresponding function file and the object library file in the rendering engine file through the interface adapter module.

7. The method according to claim 1, wherein:
the interface adapter module abstracts objects and functions needed by the user interface module into interfaces.

8. An apparatus for loading a rendering engine of mobile browser, comprising:
an updating file receiving unit configured to, when an update to the browser is needed, receive a user interface installation file and a rendering engine file separately and independently, wherein the user interface installation file includes a user interface module and an interface adapter module;
an installation unit configured to install the received user interface installation file; and
a loading unit configured to, when an application runs, dynamically load a corresponding function file and an object library file in the rendering engine file through the interface adapter module, wherein the corresponding function file and the object library file are not compiled together with the user interface adapter module.

9. The apparatus according to claim 8, wherein:
the function file loaded by the loading unit is an executable file converted from function codes.

10. The apparatus according to claim 9, wherein the loading unit is further configured to:
launch a preset system virtual machine; and
load dynamically the corresponding executable file converted from the function codes and the object library file in the rendering engine file using the system virtual machine.

11. The apparatus according to claim 8, wherein:
the rendering engine file received by the updating file receiving unit is a compressed file.

12. The apparatus according to claim 11, further including:
an uncompressing unit configured to uncompress the rendering engine file received by the updating file receiving unit, and obtain the function file and the object library file in the rendering engine file.

13. The apparatus according to claim 8, further including:
an instruction receiving unit configured to receive an operating instruction input by a user according to the user interface module,
wherein the loading unit configured to, after the instruction receiving unit receives the operating instruction, dynamically load the corresponding function file and the object library file in the rendering engine file through the interface adapter module based on the operating instruction.

14. The apparatus according to claim 8, wherein:
the interface adapter module configured to abstract objects and functions needed by the user interface module into interfaces.

15. A non-transitory computer-readable medium having computer program for, when being executed by a processor, performing a method for loading a rendering engine of a browser on a mobile terminal, the method comprising:
when an update to the browser on the mobile terminal is needed, receiving a user interface installation file and a rendering engine file separately and independently, wherein the user interface installation file includes a user interface module and an interface adapter module;
installing the received user interface installation file; and
when an application runs, loading dynamically a corresponding function file and an object library file in the rendering engine file through the interface adapter module, wherein the corresponding function file and the object library file are not compiled together with the user interface adapter module.

16. The non-transitory computer-readable medium according to claim 15, wherein:
the function file is an executable file converted from function codes; and
the loading dynamically a corresponding function file and an object library file in the rendering engine file through the interface adapter module further includes:
launching a preset system virtual machine; and
loading dynamically the corresponding executable file converted from the function codes and the object library file in the rendering engine file using the system virtual machine.

17. The non-transitory computer-readable medium according to claim 15, wherein:
the received rendering engine file is a compressed file.

18. The non-transitory computer-readable medium according to claim 15, before the loading dynamically a corresponding function file and an object library file in the rendering engine file through the interface adapter module, further including:
uncompressing the received rendering engine file; and
obtaining the function file and the object library file in the rendering engine file.

19. The non-transitory computer-readable medium according to claim 15, wherein the loading dynamically a corresponding function file and an object library file in the rendering engine file through the interface adapter module further includes:
receiving an operating instruction input by a user according to the user interface module; and
based on the operating instruction, loading dynamically the corresponding function file and the object library file in the rendering engine file through the interface adapter module.

20. The non-transitory computer-readable medium according to claim 15, wherein:
the interface adapter module abstracts objects and functions needed by the user interface module into interfaces.
